(19) United States
(12) Patent Application Publication
(10) Pub. No.: US 2023/0191935 A1
(43) Pub. Date: Jun. 22, 2023

(54) AUTONOMOUS CHARGING SYSTEM

(71) Applicant: OSAMA SULAIMAN ALSALLOUM, DAMMAM (SA)

(72) Inventor: OSAMA SULAIMAN ALSALLOUM, DAMMAM (SA)

(21) Appl. No.: 18/108,628

(22) Filed: Feb. 12, 2023

(51) Int. Cl. B60L 53/37; B60L 53/16; B25J 9/16; B25J 9/02

(52) U.S. Cl. CPC B60L 53/37; B60L 53/16; B25J 9/1679; B25J 9/02; B60L 2240/70

(57) ABSTRACT

The present invention relates to an autonomous charging system with a charging robot configured with a novel telescopic charging arm having a charging plug coupled thereto to charge an electric vehicle. When charging is completed, the plug of the charging robot decoupled itself from the electric vehicle and moves away from the electric vehicle. The system includes an end-user device, a server-based computing system, a pair of screens, and a charging robot. The charging robot is adapted to charge an electric vehicle (EV) parked at the charging location. The charging robot includes a chassis, a plurality of wheels, a prime mover coupled to a wheel shaft, a power source, at least one telescopic charging arm, a plurality of sensors, a data transmitting and receiving module, and a processor. The processor includes a navigation module, a data storage module, an arm-controlling module, a status monitoring module.

### TECHNICAL FIELD OF INVENTION

The present invention relates to an electric vehicle charging system and more particularly the present invention relates to an autonomous charging system with at least one charging robot configured with a novel telescopic charging arm having a charging plug coupled thereto to charge an electric vehicle.

### BACKGROUND

With the recent changes in environmental regulations and the trend of reducing energy costs, the demand for environmentally friendly electric vehicles is increasing. In the case of the United States and Europe, the supply of electric vehicles is made compulsory due to the enactment of the Air Conservation Act, and interest and research on eco-friendly vehicles are being actively carried out in Korea as a part of low-carbon green growth.

Various types of electric-powered vehicles, such as extended-range electric vehicles (EREVs), hybrid electric vehicles (HEVs), and electric vehicles (EVs) are available in the market. The electric power storage systems of these vehicles require periodic charging. Typically, the energy storage system is charged by connecting to a power source, such as an AC power line. The available power systems require the vehicle operator to manually couple the plug of the power cable into the vehicle's charging port. This manual operation is not always convenient for the vehicle operator. This kind of manual practice can result in missing the charging of the vehicle at the appropriate time leading to a subsequent reduction in the performance of the vehicle.

One of the Korean prior art patent document have tried to solve the above-mentioned problem through a “robot for recharging of an electric vehicle”. The Korean prior art patent discloses a robot to charge an electric vehicle which includes: a driving part that supports driving according to a predetermined pathway in a parking lot; a sensing part that senses a vehicle parked on the pathway; a verifying part that checks the registration of the vehicle the sensing part senses; and a power supplying part which supplies electric power to charge to a battery of the vehicle. According to the prior art, when a user parks his electric vehicle in a parking lot, the status of the battery is automatically checked and the charging of the battery is completed automatically. The disclosure however fails to disclose a simple, and cost-effective charging arm configured with cable and charging port. The disclosed structure in the Korean prior art is costly and complicated. Also, with disclosed structure, the charging cable is difficult to repair or replace.

Further, the location of the charging port may be different depending on the electric vehicle model and the state in which the electric vehicle is parked. Even though the available charging robots are mobile, it is difficult to carry out charging operations using such prior art charging systems.

Therefore, there is a need for an autonomous charging system configured with a charging robot having a novel telescopic charging arm with the capability to electrically couple to extended range of electric vehicles (EVs), hybrid electric vehicles (HEVs), or electric vehicles (EVs) for charging the power source housed in such electric vehicles.

### SUMMARY

The problem to be solved by the present invention is to provide an autonomous charging system comprising a charging robot with a novel telescopic charging arm that automatically couples its charging plug to an electric vehicle that requires charging its power source.

Another object of the present invention is to provide an autonomous charging system, wherein the charging robot of the autonomous charging system is easily decoupled and moved away from the electric vehicle once the charging process is complete.

Another object of the present invention is to provide a charging robot capable of moving/navigating to a charging location in advance for charging while the electric vehicle is parked at the charging location.

Another object of the present invention is to provide a charging robot that updates the battery status of an electric vehicle to an end user through an end-user device.

Another object of the present invention is to provide a charging robot with a telescopic charging arm that is simple in construction and user-friendly.

According to an exemplary non-limiting embodiment of the present invention, the system includes an end-user device adapted to define a charging location; a server-based computing system for reception of the charging location from the end-user device; and at least one charging robot adapted to charge an electric vehicle (EV) parked at the charging location.

According to an exemplary non-limiting embodiment of the present invention, the at least one charging robot includes a chassis; a plurality of wheels; a prime mover coupled to a wheel shaft; a power source comprising a plurality of rechargeable batteries; at least one telescopic charging arm configured with a plug that couples to the electric vehicle; a plurality of sensors comprising a location tracker adapted to track the location of the at least one charging robot; and an obstacle detector adapted to detect one or more obstacles present in a predefined route leading the at least one charging robot to the charging location for charging the electric vehicle; a data transmitting and receiving module configured to send and receive data over a wireless network; and a processor in communication with the server-based computing system.

According to an exemplary non-limiting embodiment of the present invention, the processor is configured to process at least: a navigation module to navigate the charging robot to the charging location for charging the electric vehicle; a data storage module including data received from the plurality of sensors to guide the navigation module; an arm-controlling module for controlling the movements of the telescopic charging arm; and a status monitoring module for monitoring a battery status of the electric vehicle (EV) and/or the at least one charging robot.

The proposed invention also discloses a method for charging an electric vehicle. The method includes a plurality of steps such as receiving by a data storage module, a charging location from a server-based computing system over a wireless network, receiving by a data storage module, a location of at least one charging robot from a location tracker configured therewith, conforming a virtual route from a plurality of predefined routes leading the at least one charging robot to the charging location for charging the electric vehicle, changing the conformed route upon detecting one or more obstacles by an obstacle detector and generating an alternate route to pass the obstacle, automatically navigating at least one charging robot to follow the route and alternate route generated, receiving by an arm controlling module, an arm controlling instructions for a telescopic charging arm from an end-user device, controlling by an arm controlling module, the movements of the telescopic charging arm using an arm-controlling module, wherein the movement of the telescopic charging arm is between a non-working position, a first working position, and a second working position thereof, coupling a plug configured with the telescopic charging arm to an electric vehicle, determining a charging status of the electric vehicle (EV) and/or the at least one charging robot using a status monitoring module, and transmitting the charging status to the end user device via the wireless network.

Various objects, features, aspects and advantages of the, present invention will become more apparent from the following detailed description of the embodiments of the invention, along with the accompanying drawings in which like numerals represent like components.

### BRIEF DESCRIPTION OF DRAWINGS

So that the manner in which the above-recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments. These and other features, benefits, and advantages of the present invention will become apparent by reference to the following text figure, with like reference numbers referring to like structures across the views, wherein:

FIG. 1 shows an exploded view of a charging robot in accordance with the present invention;

FIG. 2 shows a view of the charging robot with a charging arm at a second working position;

FIG. 3 shows a view of FIG. 2 without the charging arm;

FIG. 4 shows a view of the charging robot with a protective shield in accordance with the present invention;

FIG. 5 shows a 2D view of the charging arm of FIG. 1 at a non-working position;

FIGS. 6 and 7 show 2D views of FIG. 5 at a second working position;

FIGS. 8, 9, and 10 show 3D views of the charging arm of FIG. 1 at a non-working position, a first working position, and a second working positions respectively;

FIGS. 11, 12, 13, 14, 15, and 16 shows 2D views of the charging arm configured with an inflating arm mechanism, a gear drive mechanism, a belt and pulley mechanism, a scissor lift mechanism, a lead screw mechanism, and a pneumatic or hydraulic mechanism respectively;

FIGS. 17, 18, and 19 shows views of the charging arm configured with a male port, a female port, and an inductive port respectively;

FIGS. 20, 21, and 22 show use case scenarios of the autonomous charging system particularly charging robot coupled to an electric vehicle;

FIG. 23 shows another use case view of an autonomous charging system coupled to an end user device;

FIG. 24 shows a block diagram for an autonomous charging system in accordance with the present invention;

FIG. 25 shows a block diagram for a processor of FIG. 24;

FIG. 26 shows a block diagram for an obstacle detector of FIG. 24;

FIG. 27 shows a flow chart for a method for charging an electric vehicle.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, several materials are identified as suitable for various facets of the implementations. These materials are to be treated as exemplary and are not intended to limit the scope of the invention.

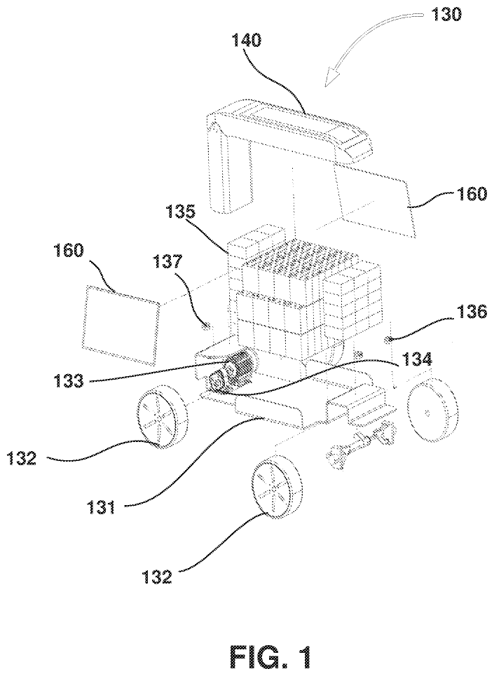

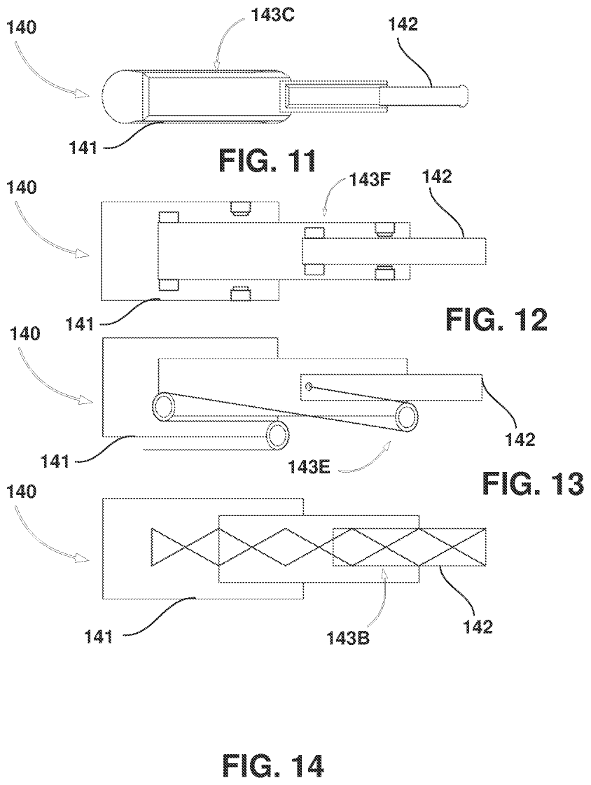

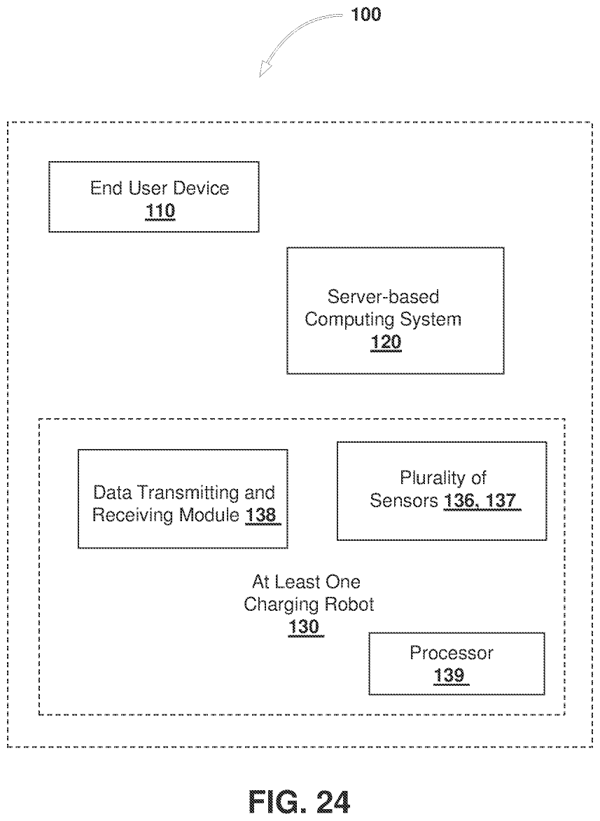

The various features and embodiments of the present invention will now be described in conjunction with the accompanying figures, namely FIGS. 1-26, which should be regarded as merely illustrative without restricting the scope and ambit of the present invention.

The present invention relates to an autonomous charging system having at least one charging robot configured with a novel telescopic charging arm that automatically couples a plug connected therewith to charge the battery of the electric vehicle. When charging is completed, the plug of the charging robot is decoupled from the electric vehicle and moved away from the electric vehicle.

From herein afterward, the system is to referred as a system 100, the robot is to referred as a robot 130 and the method is to referred as a method 300.

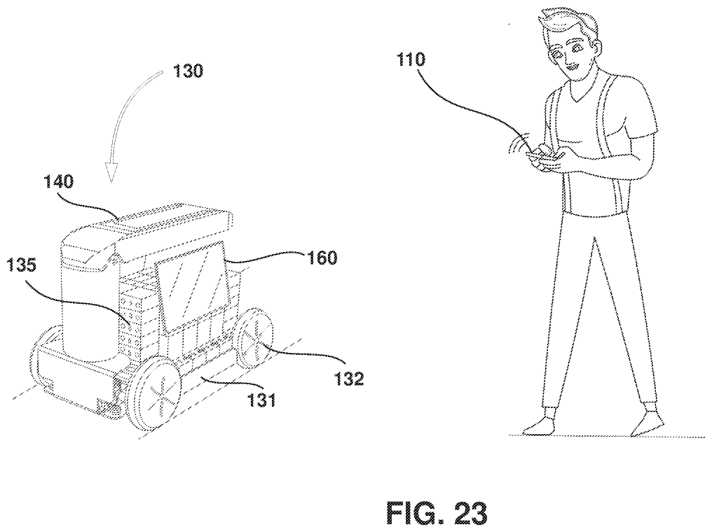

Referring now to FIG. 24, the system 100 includes an end-user device 110, a server-based computing system 120, and at least one charging robot 130.

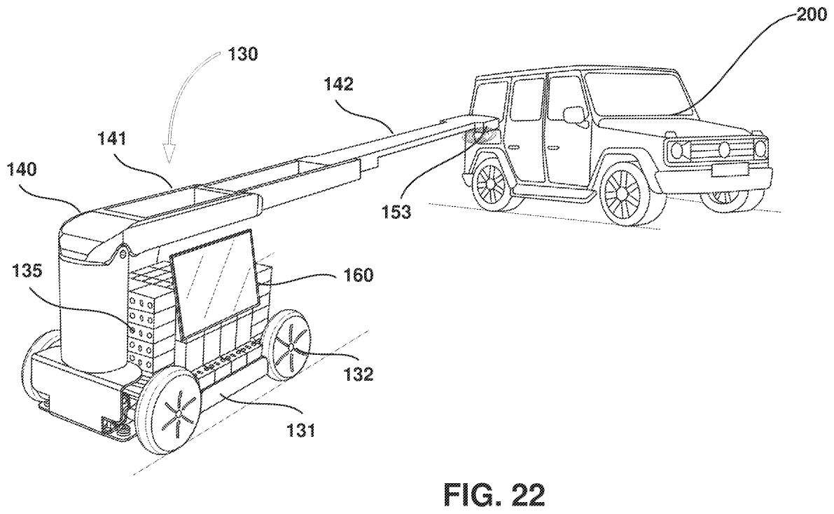

The end-user device 110 is adapted to define a charging location. The end user device 110 includes a mobile phone, a laptop computer, a personal computer, a tablet computer, a smartwatch, or any other Internet of Things based electronic device embedded with an android, an iOS operating system or web-based operating system. The end user device 110 is provided with a user interface (basically a software module for hardware interface modules), a display module, and an input module. The display module includes a monitor, and any other electronic display module. The input module may include a keyboard, a keypad, a touch screen, a smart pencil, a voice command system, etc. One of the end user devices 110 is assigned to an authorized user as shown in FIG. 23. The authorized user may be an owner of the system 100.

The server-based computing system 120 receives the charging location from the end user device 110. The charging location may be a parking location of a mall, stadium, or any other place where extended-range electric vehicles (EREVs), hybrid electric vehicles (HEVs), or electric vehicles (EVs) are parked. The server-based computing system 120 uses a communication module. The communication module includes an internet, a wi-fi module, a frequency waves-based data sharing module such as Bluetooth, or a satellite-based data sharing module, etc. The server-based computing system 120 allows the user to access the data stored in the database through the communication module.

The charging robot 130 is adapted to charge an electric vehicle 200 (EV) parked at the charging location. Referring now to FIG. 1 along with FIG. 24, the charging robot 130 includes a chassis 131, a plurality of wheels 132, a prime mover 133 coupled to a wheel shaft 134, a power source 135, at least one telescopic charging arm 140, a plurality of sensors 136, 137, a data transmitting and receiving module 138, and a processor 139.

The power source 135 includes a plurality of rechargeable batteries. The rechargeable batteries may be replaceable with a new set of batteries. The batteries are recharged using solar energy, chemical energy, or electric energy from another battery or storage system.

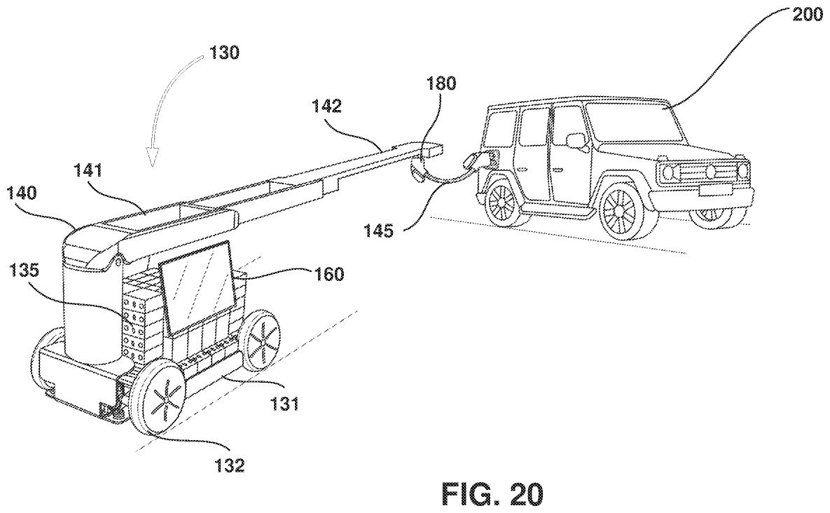

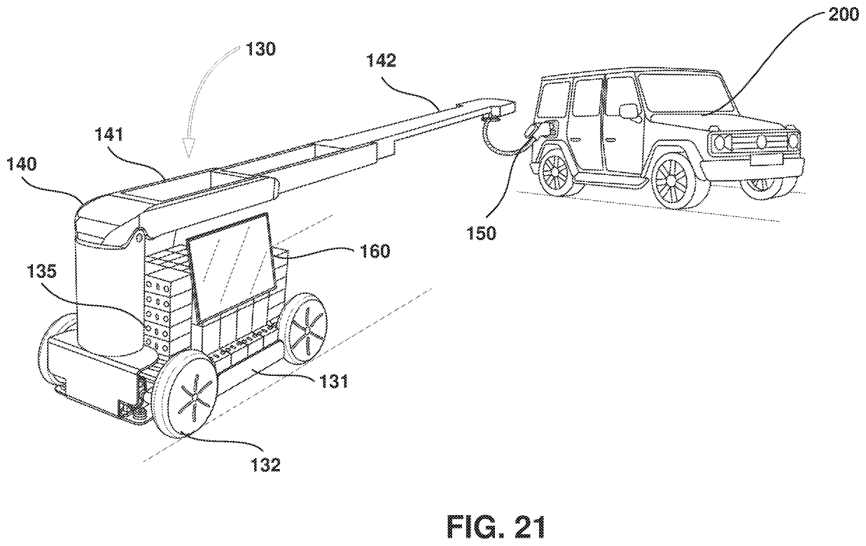

The telescopic charging arm 140 includes a plurality of segments 141, 142, arm-moving mechanisms (143A-143F) referred to as 143, and a cable reel (not seen). The plurality of segments 141, 142 includes a primary segment 141 and one or more secondary segments 142. The telescopic charging arm 140 is configured with a plug 150. The plug 150 couples to the electric vehicle 200 as shown in FIGS. 20, 21, and 22. One of the secondary segments 142 is configured to have the plug 150. The plug 150 is adapted to have a male port 151 as shown in FIG. 17 that gets coupled with a female port. The plug 150 is adapted to have a female port 152 as shown in FIG. 18 that gets coupled with a male port of another cable. Referring now to FIG. 19, the plug 150 is adapted to have an inductive port 153.

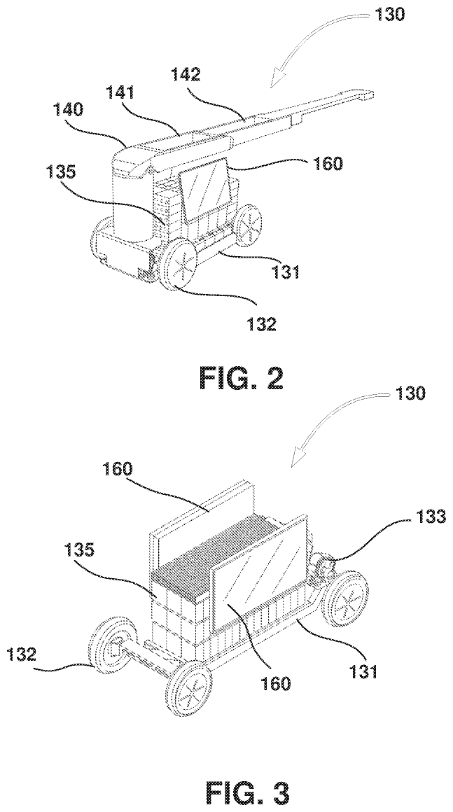

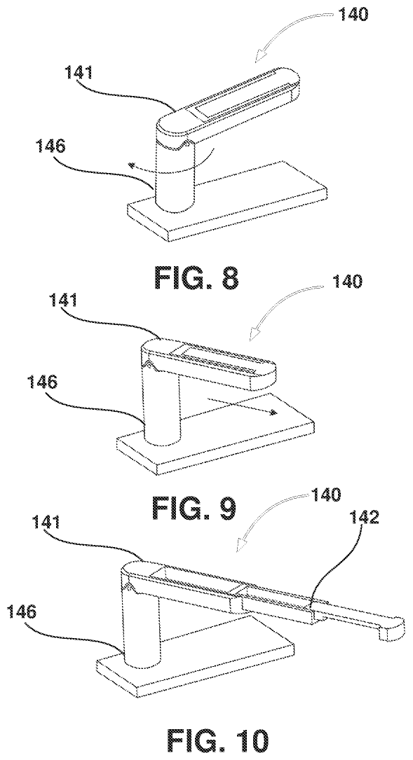

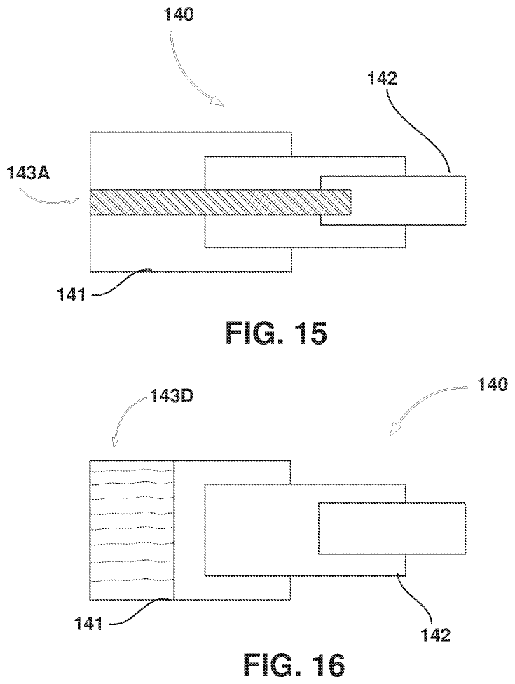

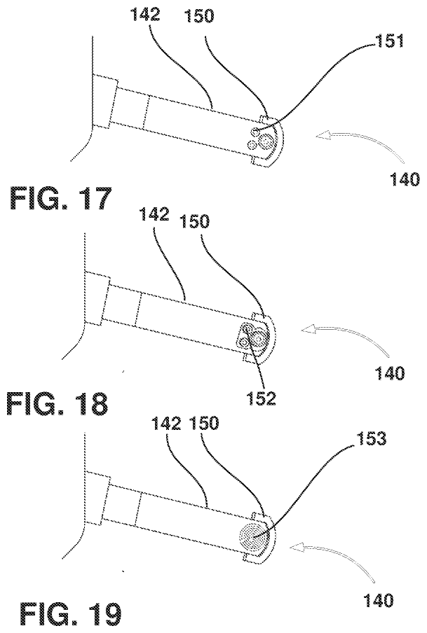

The arm-moving mechanism 143 moves the plurality of segments 141, 142 between a non-working position, a first working position, and a second working position. The arm moving mechanism 143 comprises at least a lead screw mechanism 143A (Refer FIG. 15), a scissor lift mechanism 143B (Refer FIG. 14), an inflating arm mechanism 143C (Refer FIG. 11), a gear drive mechanism 143F (Refer FIG. 12), a pneumatic or hydraulic mechanism 143D (Refer FIG. 16), or a belt and pulley mechanism 143E (Refer FIG. 13). The secondary segments 142 rest inside the primary segment 141 of the telescopic charging arm 140 at the non-working position as shown in FIGS. 5 and 8. The telescopic charging arm 140 with the primary segment 141 and nested secondary segments 142 are arranged inside the primary segment 141 rotates about a pivot 146 to achieve the first working position as shown in FIG. 9. Referring now to FIGS. 2, 6, 7, and 10, the secondary segments 142 of the telescopic charging arm 140 get extended outside the primary segment 141 to achieve the second working position after the first working position or directly after the non-working position.

The cable reel (not seen) houses at least a portion of a cable 145. A first end of the cable reel is coupled to the power source 135 and a second end of the cable reel is coupled to the plug 150. The one or more secondary segments 142 carry a portion of cable 145 therewith when extended outside the primary segment 141. The extended portion of the cable 145 is configured to automatically retract after the secondary segments 142 are retracted inside the primary segment 141 to achieve the non-working position. The user is allowed to couple the cable plug 150 to the vehicle's charging port as shown in FIG. 21. Also, the user is allowed to couple the vehicle cable port 180 to the plug 150 as showed in FIG. 20. Also, the user can user the inductive or wireless port 153 as shown in FIG. 22 for charging purpose.

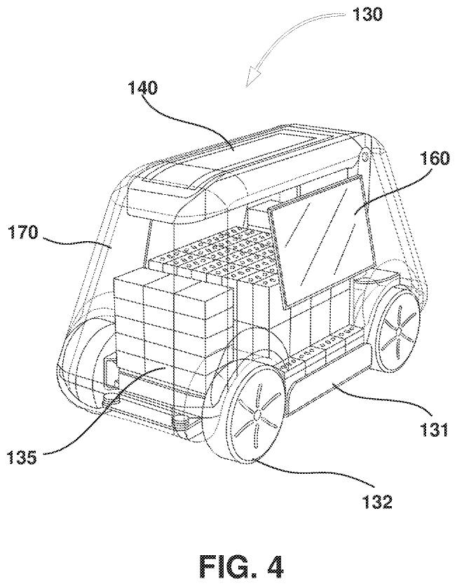

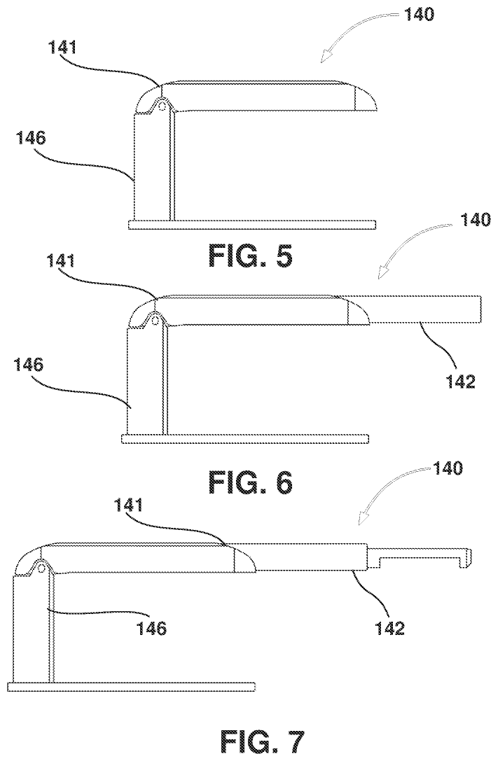

Referring now to FIG. 3, the robot 130 is provided with a pair of screens 160. The screens 160 display a pre-stored data. The pre-stored data is displayed in the form of images, frames of images forming a video, or advertising content rendered by third parties. Referring now to FIG. 4, a protective shield 170 is provided for protecting the screens 160. The shield 170 is made from a transparent or translucent material and allows a user to watch content played on the screens 160. The screens 160 are configured on side surfaces of the robot 130.

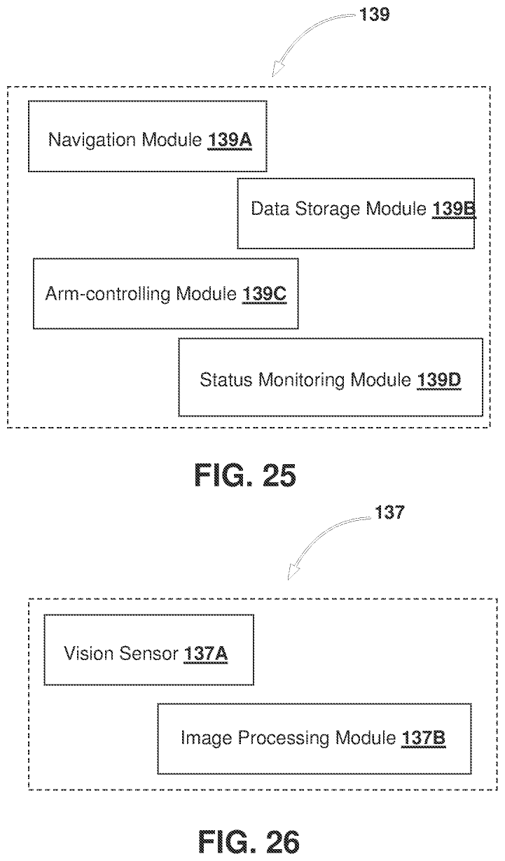

Referring now to FIG. 24, the plurality of sensors 136, 137 includes a location tracker 136 and an obstacle detector 137. The location tracker 136 is adapted to track the location of the at least one charging robot 130. The location tracker 136 may include global positioning system or with a predefined electronic map of parking space or wireless communication based tracking system. The obstacle detector 137 is adapted to detect one or more obstacles present in a predefined route leading the at least one charging robot 130 to the charging location for charging the electrical vehicle. Referring now to FIG. 26, the obstacle detector 137 includes a vision sensor 137A and an image processing module 137B. The vision sensor 137A captures one or more images. The image processing module 137B compares the captured images with a plurality of images stored in a database to identify the obstacle. In one more alternative embodiment of the present invention, the obstacle detector 137 includes a proximity sensor for detecting nearby objects.

The data transmitting and receiving module 138 is configured to send and receive data over a wireless network. The processor 139 is in communication with the server-based computing system 120. The processor 139 may be a processor, a microprocessor, a computer, a microcomputer, a controller or a microcontroller. The processor 139 is integrated with a plurality of hardware modules and software modules such as a navigation module 139A, a data storage module 139B, an arm-controlling module 139C, a status monitoring module 139D. It is possible for a person skilled in the art to add or remove software modules as per requirements after reading the present patent specification.

The navigation module 139A navigates the charging robot 130 to the charging location for charging the electric vehicle 200. The data storage module 139B stores a data received from the plurality of sensors 136, 137 to guide the navigation module 139A. The arm-controlling module 139C controls the movements of the telescopic charging arm 140. The status monitoring module 139D monitors a battery status of the electric vehicle 200 (EV) and/or the at least one charging robot 130.

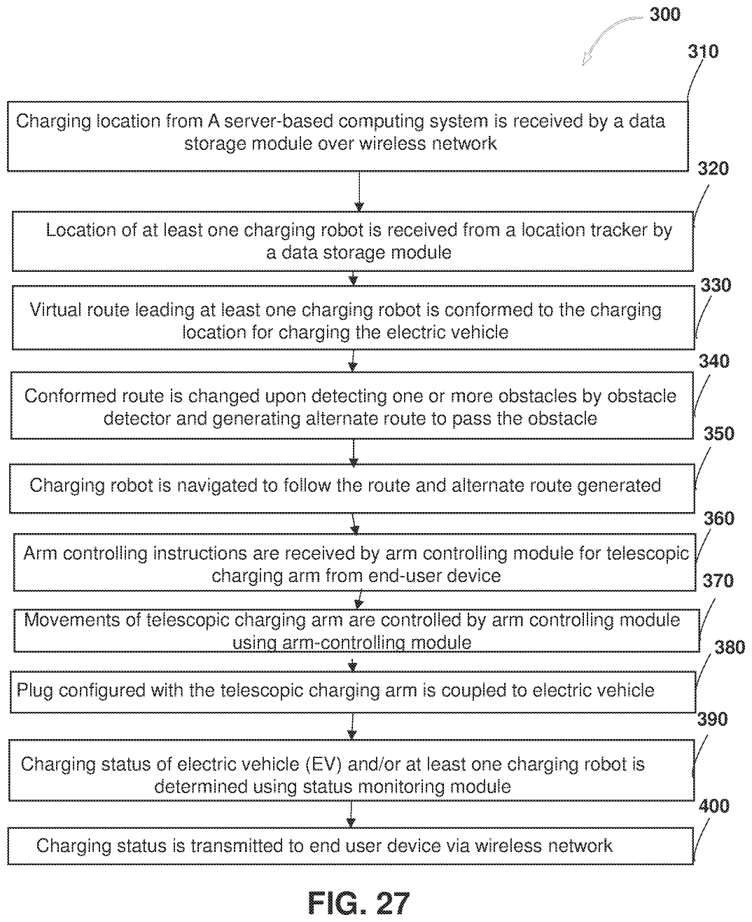

Referring now to FIG. 27, the present invention also provides the method 300 for charging the electric vehicle 200 using the system 100. The method 300 includes an initial step 310 of receiving the charging location from the server-based computing system 120 over the wireless network by the data storage module 139B.

At step 320, the location of at least one charging robot 130 is received by the data storage module 139B from the location tracker 136 configured therewith.

At step 330, the virtual route from the plurality of predefined routes leading the at least one charging robot 130 to the charging location is conformed for charging the electric vehicle 200.

At step 340, the conformed route is changed upon detecting one or more obstacles by the obstacle detector 137 and generating the alternate route to pass the obstacle.

At step 350, at least one charging robot 130 is navigated automatically to follow the route and alternate route generated.

At step 360, the arm controlling instructions are received by the arm controlling module for the telescopic charging arm 140 from the end-user device 110.

At step 370, the movements of the telescopic charging arm 140 are controlled by the arm controlling module using the arm-controlling module 139C. The movement of the telescopic charging arm 140 is between the non-working position, the first working position, and the second working position thereof.

At step 380, the plug 150 is coupled to the electric vehicle 200.

At step 390, the charging status of the electric vehicle 200 (EV) and/or the at least one charging robot 130 is determined using the status monitoring module 139D.

At step 400, the charging status is transmitted to the end user device via the wireless network.

The method 300 also includes a step of storing the plurality of predefined data comprising the plurality of predefined processing instructions, the plurality of images, the map with the plurality of predefined routes and alternate routes; the charging status in the database. The method 300 also includes the step of displaying at least pre-stored data in the form of images, frames of images forming the video, or advertising content rendered by third parties. on the at least the pair of screens 160. The method 300 also includes the step of carrying the portion of cable 145 of the cable reel configured with the telescopic charging arm 140 when one or more secondary segments 142 of the telescopic charging arm 140 expanded outside a primary segment 141 of the telescopic charging arm 140.

The present invention provides an advantage of providing the autonomous charging system 100 comprising the charging robot 130 with the novel telescopic charging arm 140 that automatically couples its charging plug 150 to the electric vehicle 200 that requires charging its power source. The system 100 is proved useful in parking zones of stadium, gardens, government offices, public parking places etc. where extended-range electric vehicles (EREVs), the hybrid electric vehicles (HEVs), or the electric vehicles (EVs) are parked. The system 100 is also useful at charging stations. The robot 130 gets decoupled and moves away from the electric vehicle 200 once the charging process is complete. The robot 130 is capable of moving/navigating to the charging location in advance for charging while the electric vehicle is parked at the charging location. The system 100 reduces manual efforts. The system 100 updates the battery status of an electric vehicle 200 to an end user through an end-user device 110. The system 100 is simple in construction and user-friendly.

It should be understood according to the preceding description of the present invention that the same is susceptible to changes, modifications and adaptations, and that the said changes, modifications and adaptations fall within scope of the appended claims

What is claimed is:

1. An autonomous charging system (100), comprising:
an end-user device (110) adapted to define a charging location;
a server-based computing system (120) for reception of the charging location from the end user device; and
at least one charging robot (130) adapted to charge an electric vehicle (EV) (200) parked at the charging location, the at least one charging robot (130) comprising:
a chassis (131);
a plurality of wheels (132);
a prime mover (133) coupled to a wheel shaft (134);
a power source (135) comprising a plurality of rechargeable batteries;
at least one telescopic charging arm (140) configured with a plug (150) that couples to the electric vehicle (200);
a plurality of sensors (136, 137) comprising a location tracker (136) adapted to track the location of the at least one charging robot (130); and an obstacle detector (137) adapted to detect one or more obstacles present in a predefined route leading the at least one charging robot (130) to the charging location for charging the electric vehicle (200);
a data transmitting and receiving module (138) configured to send and receive data over a wireless network; and
a processor (139) in communication with the server-based computing system (120), the processor (139) is configured to process at least:
a navigation module (139A) to navigate the charging robot (130) to the charging location for charging the electric vehicle (200);
a data storage module (139B) including data received from the plurality of sensors (136, 137) to guide the navigation module (139A);
an arm-controlling module (139C) for controlling the movements of the telescopic charging arm (140); and
a status monitoring module (139D) for monitoring a battery status of the electric vehicle (200) (EV) and/or the at least one charging robot (130).

2. The autonomous charging system (100) of claim 1, wherein the obstacle detector (137) further comprising:
a vision sensor (137A) adapted to capture one or more images; and
an image processing module (137B) that compares the captured images with a plurality of images stored in a database to identify the obstacle.

3. The autonomous charging system (100) of claim 1, wherein the at least one charging robot (130) further comprising at least a pair of screens (160) to display at least pre-stored data in the form of images, frames of images forming a video, or advertising content rendered from third parties.

4. The autonomous charging system (100) of claim 1, wherein the telescopic charging arm (140) further comprising:
a plurality of segments (141, 142) comprising a primary segment (141), and one or more secondary segments (142);
an arm-moving mechanism (143) that moves the plurality of segments (141, 142) between a non-working position, a first working position, and a second working position; and
a cable reel for housing at least a portion of a cable (145).

5. The autonomous charging system (100) of claim 4, wherein one of the secondary segments (142) forming the telescopic charging arm (140) is configured to have the plug (150).

6. The autonomous charging system (100) of claim 5, wherein the plug (150) is adapted to have at least: a male port (151), a female port (152), or an inductive port (153).

7. The autonomous charging system (100) of claim 4, wherein the arm moving mechanism (143) comprises at least a lead screw mechanism (143A), a scissor lift mechanism (143B), an inflating arm mechanism (143C), a pneumatic or hydraulic mechanism (143D), a gear drive mechanism (143F) or a belt and pulley mechanism (143E).

8. The autonomous charging system (100) of claim 4, wherein the one or more secondary segments (142) rest inside the primary segment (141) of the telescopic charging arm (140) at a non-working position.

9. The autonomous charging system (100) of claim 4, wherein the telescopic charging arm (140) with the primary segment (141) and nested secondary segments (142) arranged there inside rotates about a pivot (146) to achieve the first working position.

10. The autonomous charging system (100) of claim 4, wherein the one or more secondary segments (142) of the telescopic charging arm (140) get extended outside the primary segment (141) to achieve the second working position after the first working position or directly after the non-working position.

11. The autonomous charging system (100) of claim 4, wherein a first end of the cable reel is coupled to the power source (135) and a second end of the cable reel is coupled to the plug (150).

12. The autonomous charging system (100) of claim 4, wherein the one or more secondary segments (142) carry a portion of cable (145) therewith when extended outside the primary segment (141).

13. The autonomous charging system (100) of claim 12, wherein the extended portion of the cable (145) is configured to automatically retract after the secondary segments (142) are retracted inside the primary segment (141) to achieve the non-working position.

14. A method (300) for charging an electric vehicle (200) comprising:
receiving, by a data storage module (139B), a charging location from a server-based computing system (120) over a wireless network;
receiving, by a data storage module (139B), a location of at least one charging robot (130) from a location tracker (136) configured therewith;
conforming a virtual route from a plurality of predefined routes leading the at least one charging robot (130) to the charging location for charging the electric vehicle (200);
changing the conformed route upon detecting one or more obstacles by an obstacle detector (137) and generating an alternate route to pass the obstacle;
automatically navigating at least one charging robot (130) to follow the route and alternate route generated;
receiving by an arm controlling module, an arm controlling instructions for a telescopic charging arm (140) from an end-user device (110);
controlling by an arm controlling module, the movements of the telescopic charging arm (140) using an arm-controlling module (139C), wherein the movement of the telescopic charging arm (140) is between a non-working position, a first working position, and a second working position thereof;
coupling a plug (150) configured with the telescopic charging arm (140) to an electric vehicle (200);
determining a charging status of the electric vehicle (200) (EV) and/or the at least one charging robot (130) using a status monitoring module (139D); and
transmitting the charging status to the end user device via the wireless network.

15. The method (300) of claim 14, wherein the step of detecting the obstacle by the obstacle detector (137) further comprising steps of:
receiving by an image processing module (137B), one or more images captured by a vision sensor (137A) configured with the charging robot (130);
comparing by the image processing module (137B), the one or more captured images with a plurality of images stored in a database using an image processing module (137B); and
determining by an image processing module (137B), parameters of the detected obstacle such as dimensions, shape etc. based on the compared data.

16. The method (300) of claim 14, further comprising a step of storing a plurality of predefined data comprising the plurality of predefined processing instructions, a plurality of images, a map with a plurality of predefined routes and sub routes; a charging status in a database.

17. The method (300) of claim 14, further comprising a step of displaying at least pre-stored data in the form of images, frames of images forming a video, or advertising content rendered by third parties on an at least a pair of screens (160).

18. The method (300) of claim 14, wherein the at least one charging robot (130) comprising:
a chassis (131);
a plurality of wheels (132);
a prime mover (133) coupled to a wheel shaft (134);
the power source (135) comprising a plurality of rechargeable batteries;
at least one telescopic charging arm (140) configured with the plug (150) that couples to the electric vehicle (200);
a plurality of sensors (136, 137) comprising the location tracker (136) adapted to track the location of the at least one charging robot (130); and the obstacle detector (137) adapted to detect one or more obstacles present in the predefined route leading the at least one charging robot (130) to the charging location for charging the electrical vehicle;
a data transmitting and receiving module (138) configured to send and receive data over a wireless network; and
a processor (139) in communication with the server-based computing system (120), the processor (139) is configured to process at least:
the navigation module (139A) to navigate the charging robot (130) to the charging location for charging the electric vehicle (200);
a data storage module (139B) including data received from the plurality of sensors (136, 137) to guide the navigation module (139A);
the arm-controlling module (139C) for controlling the movements of the telescopic charging arm (140); and
the status monitoring module (139D) for monitoring the battery status of the electric vehicle (200) (EV) and/or the at least one charging robot (130).

19. The method (300) of claim 14, further comprising a step of carrying a portion of cable (145) of a cable reel configured with the telescopic charging arm (140) when one or more secondary segments (142) of the telescopic charging arm (140) expanded outside a primary segment (141) of the telescopic charging arm (140).

20. The method (300) of claim 14, further comprising a step of retracting the extended portion of the cable (145), once the secondary segments (142) retracted inside the primary segment (141).

21. The method (300) of claim 14, further comprising a step of decoupling the plug (150) from the electric vehicle (200) in response to charging being complete
